(19) United States
(12) Patent Application Publication
(10) Pub. No.: US 2010/0228658 A1
(43) Pub. Date: Sep. 9, 2010

(54) SYSTEM AND METHOD FOR CREDIT REPORTING

(75) Inventors: Brian Jeffrey Ketelsen, Land O Lakes, FL (US); Timothy Ranney, Clearwater, FL (US)

Correspondence Address: CONNOLLY BOVE LODGE & HUTZ, LLP, P O BOX 2207, WILMINGTON, DE, 19899, US

(73) Assignee: CLARITY SERVICES, INC., Clearwater, FL (US)

(21) Appl. No.: 12/718,589

(22) Filed: Mar. 5, 2010

Related U.S. Application Data
(60) Provisional application No. 61/158,176, filed on Mar. 6, 2009.

(51) Int. Cl. G06F 17/30; G06F 15/177; G06Q 10/00; G06Q 40/00

(52) U.S. Cl. 705/35; 707/770; 709/221; 705/318; 707/E17.014

(57) ABSTRACT

A system for providing creditworthiness information based on a credit application, including: at least one database storing a plurality of information elements corresponding to credit information; and at least one server configured to: receive at least one data file including first additional information elements and store the additional data elements in the at least one database using batch processing; receive at least one record including second additional information elements and storing the second additional information elements in the database substantially contemporaneously with their being received; receive creditworthiness requests; automatically query the at least one database including the information elements, first additional information elements and second additional information elements dependently upon the received requests substantially contemporaneously with the requests being received to generate query results; and automatically transmit creditworthiness indicative information based upon the query results substantially contemporaneously with the query results being generated.

### RELATED APPLICATION

This application claims priority of U.S. Provisional Patent Application Ser. No. 61/158,176, filed Mar. 6, 2009, and entitled REAL-TIME CREDIT REPORTING, the entire disclosure of which is hereby incorporated by reference as if being set forth in its entirety herein.

### FIELD OF THE INVENTION

The present invention generally relates to a computerized systems and methods, and credit reporting.

### BACKGROUND OF THE INVENTION

A loan is a type of debt, between the lender and the borrower. A borrower receives or borrows an amount of money from a lender, and is obligated to pay back or repay the lender at a later time. Typically, the money may be paid back as a single payment, or as partial repayments. Loans are generally provided at a cost, referred to as interest on the debt, which provides an incentive for the lender to engage in the loan. In a legal loan, each of these obligations and restrictions is enforced by contract, which can also place the borrower under additional restrictions known as loan covenants.

It is important for a potential lender to understand the likelihood that a potential borrower will be able and willing to repay the potential debt. Accordingly, lenders may typically require a potential borrower to complete a loan or credit application. “Loan application”, as used herein, generally refers to the process of filling a paper or electronic form(s) with personal information that a lender can use to determine whether the potential borrower is eligible for a loan.

A lender, such as a financial institution or a bank, a service provider, retailer or other credit-providing third party, by way of non-limiting example only, may typically utilize a defined business process to extract the information, evaluate it, and score the loan application before making a final decision. Scoring is typically a significant step of the loan application process, where a statistical value is applied on each of the application's elements, including age, profession, income, marital status and calculating the potential borrower's credit score.

A credit score is a numerical expression based on a statistical analysis of a person's credit files, to represent the creditworthiness of that person. A credit score may conventionally be primarily based on credit report information typically sourced from credit bureaus. In the United States, credit scores are often based on credit report information, typically from one of three major credit bureaus: Experian, TransUnion, and Equifax.

There are different methods of calculating credit scores. FICO, the most widely known type of credit score, is a credit score developed by FICO, previously known as Fair Isaac Corporation. It is used by many mortgage lenders that use a risk-based system to determine the possibility that the borrower may default on financial obligations to the mortgage lender. The credit bureaus all have their own credit scores: Equifax's ScorePower, Experian's PLUS score, and TransUnion's credit score, and each also sells the VantageScore credit score.

Notwithstanding such maturity in the loan application process, and the lending industry in general, recent history shows an increase in defaults in loans.

One subset of lending believed to be at significant increased risk is that which relates to the so-called subprime market. Subprime lending (e.g., near-prime, non-prime, or second-chance lending) as used herein refers generally to making loans that are in the riskiest category of consumer loans and are typically sold in a separate market from prime loans. Although there is no single, standard definition, in the United States subprime loans may often be classified as those where the borrower has a FICO score below 640. Subprime lending encompasses a variety of credit types, including mortgages, auto loans, and credit cards.

Improved systems and methods for processing loan applications, in an effort to reduce default occurrences while maintaining loan origination business is desirable.

### SUMMARY OF THE INVENTION

In certain embodiments of the present invention, a system for providing creditworthiness information based on a credit application may be provided. Such a system may include: at least one database storing a plurality of information elements corresponding to credit information; and at least one server. The server may be configured to receive at least one data file including first additional information elements and store the additional data elements in the at least one database using batch processing; receive at least one record including second additional information elements and storing the second additional information elements in the database substantially contemporaneously with their being received; receive creditworthiness requests; query the at least one database including the information elements, first additional information elements and second additional information elements dependently upon the received requests substantially contemporaneously with the requests being received to generate query results; and transmit creditworthiness indicative information based upon the query results substantially contemporaneously with the query results being generated.

In certain embodiments of the present invention, a system for providing creditworthiness information in response to an application corresponding to an applicant may be provided. The system may include at least one server. The server may be configured to: receive the application; parse out information items in the application; compare at least one of the parsed out information items to information items previously parsed out from other applications also corresponding to the applicant; and for each of a plurality of temporal periods, indicating the aggregate of: (1) a number of information inconsistencies determined to exist between the at least one parsed information item and the previously parsed information items received in the corresponding temporal period; and (2) inconsistencies in the previously parsed information items received in the corresponding temporal period.

In certain embodiments of the present invention, a system for providing creditworthiness information based on a credit application from a plurality of requestors may be provided. The system may include at least one database storing a plurality of information elements corresponding to credit information and a plurality of configuration types each corresponding to one of the requestors and a type of request; and at least one server. The server may be configured to: receive creditworthiness requests from the requestors; determine which of the configuration types corresponds to each of the received requests; query the at least one database dependently upon the received requests substantially contemporaneously with the requests being received and in accordance with the determined configuration files to generate query results; and transmit creditworthiness indicative information based upon the query results substantially contemporaneously with the query results being generated; wherein the types of transmitted information may differ based upon the determined configuration types.

In certain embodiments of the present invention, there may be provided a system for providing creditworthiness information based on a credit application. The system may include: at least one database storing a plurality of information elements corresponding to credit information and particular computing device indicative information; and at least one server. The server may be configured to: receive creditworthiness requests; query the at least one database including the information elements and the particular computing device indicative information dependently upon the received requests substantially contemporaneously with the requests being received to generate query results; and transmit creditworthiness indicative information based upon the query results substantially contemporaneously with the query results being generated.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts, and in which:

FIG. 1 illustrates a block diagrammatic representation of a system according to an embodiment of the present invention;

FIG. 2 illustrates an example of a report suitable for presenting consumer data as submitted for processing in connection with loan applications according to an embodiment of the present invention;

FIG. 3 illustrates an example of a report suitable for identifying loan applicants that may be attempting to commit identity fraud according to an embodiment of the present invention;

FIG. 4 illustrates an example report suitable for identifying loan applicants that are related to a common computing device or computing address according to an embodiment of the present invention;

FIG. 5 illustrates an example of a report suitable for providing bank account risk information according to an embodiment of the present invention;

FIGS. 6a and 6b illustrate examples of reports useful for loan application approval/denial processing and/or automation of underwriting functions according to embodiments of the present invention;

FIGS. 7a and 7b illustrate examples of reports suitable for providing real-time credit reporting according to embodiments of the present invention;

FIG. 8 illustrates an example of a report suitable for providing recent-historical loan applicant demographic information according to an embodiment of the present invention; and

FIGS. 9-12 illustrate exemplary process flows according to certain embodiments of the present invention.

### DETAILED DESCRIPTION OF THE PREFERRED EMBODIMENTS OF THE INVENTION

It is to be understood that the figures and descriptions of embodiments of the present invention have been simplified to illustrate elements/steps relevant for a clear understanding of the present invention, while eliminating, for the purpose of clarity, other elements/steps found or used in typical presentation, production, data delivery and/or computing systems, devices and processes. Those of ordinary skill in the art may recognize that other elements and/or steps are desirable and/or required in implementing embodiments of the present invention. However, because such elements and steps are well known in the art, and do not facilitate a better understanding of the present invention, a discussion of such elements/steps is not provided herein.

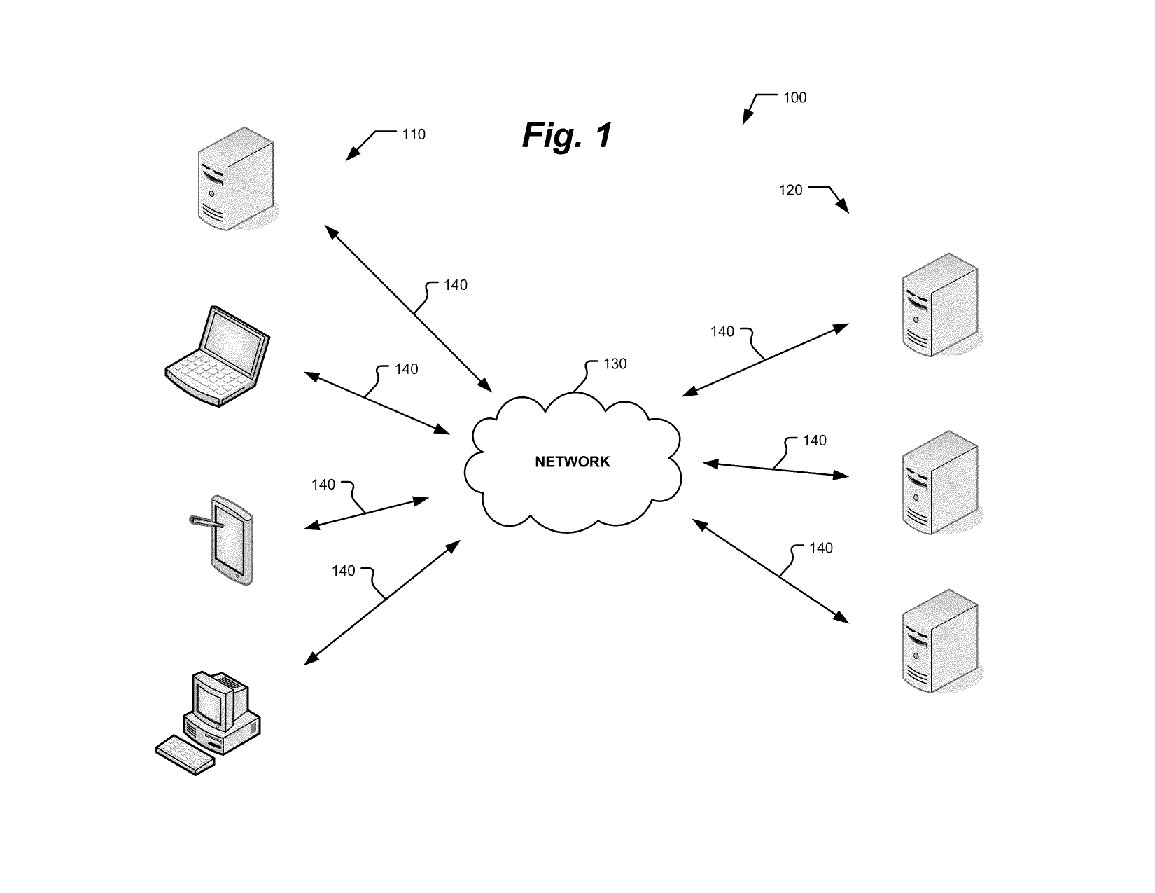

Referring now to FIG. 1, there is shown a configuration of a system 100 according to an embodiment of the present invention. In certain embodiments of the present invention, system 100 is well-suited for performing and/or providing functionalities described herein.

System 100 generally includes a first class of computing devices 110 and a second class of computing devices 120. The groups may but need not be mutually exclusive. For example, one or more computing devices may be members of more than one of classes 110, 120. Generally, each of the computing devices of classes 110, 120 are communicatively interconnected with one another via at least one data compatible network 130, such as the global interconnection of computers and computer networks commonly referred to as the Internet, and/or other wireline and/or wireless telecommunications networks. In the illustrated embodiment of FIG. 1, the computing devices of class 110 are interconnected with the computing devices of class 120 via network 130 and network connections 140. In certain embodiments of the present invention, one or more of these computing device interconnections may take the form of wireline and/or wireless Internet or other data network connections.

In certain embodiments of the present invention, class 110 computing devices may include end-user computing devices, such as personal computers, for example. In certain embodiments of the present invention class 110 computing devices may include servers, for example. In certain embodiments of the present invention, class 110 computing devices may include network or system servers. In certain embodiments of the present invention, computing devices in class 110 provide back office services for lenders. In certain embodiments of the present invention, computing devices in class 110 may provide one or more websites that are accessible by loan applicants to directly complete loan applications, for example. In certain embodiments of the present invention, computing devices in class 110 may include elements of a lender's computing network, and provide for data entry or accumulation of information from loan applications. In certain embodiments of the present invention, computing devices in class 110 interchange data with computing devices in class 120, for example. For example, loan application and/or account information may be sent from devices 110 and received by devices 120. Creditworthiness information may be sent by devices 120 and received by devices 110.

In certain embodiments of the present invention, class 120 computing devices may generally take the form of servers, for example. In certain embodiments of the present invention, class 120 computing devices may correspond to network or system servers. Computing devices in class 120 may provide processing tools or services that implement embodiments of the present invention. Class 120 computing devices may provide one or more websites that are accessible by computing devices in class 110, for example.

By way of non-limiting explanation, “computing device”, as used herein, generally refers to a general purpose computing device that includes a processor. A processor, such as a microprocessor, as used herein, generally includes a Central Processing Unit (CPU). A CPU generally includes an arithmetic logic unit (ALU), which performs arithmetic and logical operations, and a control unit, which extracts instructions (e.g., code) from a computer readable medium, such as a tangible memory, and decodes and executes them, calling on the ALU when necessary. “Memory”, as used herein, generally refers to one or more devices or media capable of storing data, such as in the form of chips or drives. For example, memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including the processor. Memory may take the form of magnetic or optical—technology based storage media. Memory may be internal or external to a computing device. Memory may store a computer program, e.g., code or a sequence of instructions being operable by the processor. In certain embodiments of the present invention, one or more elements may take the form of, or functionalities discussed may be provided using, code being executed using one or more computing devices, such as in the form of computing device executable programs or applications being stored in memory. There are various types of computing devices, having varying processing and memory capabilities, such as: personal computers (like those that are commercially available from Dell and Apple Corp, by way of non-limiting example only.

A “server”, as used herein, is generally communicatively coupled to a network, and manages network resources. A server may refer to a discrete computing device, or may refer to an application that is managing resources rather than a discrete computing device. “Network”, as used herein, generally refers to a group of two or more computing devices communicatively connected to one-another.

“Website”, as used herein, generally refers to a collection of one or more electronic documents (e.g., webpages) that are available via a computer and/or data compatible network, such as the Internet. By way of non-limiting example, a website may typically be accessed at a given address on the World Wide Web (e.g., “www.URL.TLD”), and include a home page, which is the first webpage visitors typically see when they enter the site. A website may also contain additional webpages. Webpages may be fixed, and/or dynamically generated in response to website visitor webpage requests. By way of further non-limiting example only, the World Wide Web is a system of Internet servers that generally support HTML (Hypertext Markup Language), such that a website visitor can jump from one webpage to another webpage by clicking on references to other webpages, such as hot spots or hot links (sometimes referred to as “links”). Web browsing applications, such as Microsoft's Internet Explorer, Google's Chrome, and Apple's Safari are commercially available applications typically used to access websites on the World Wide Web. Webpages are typically served by servers. Other computer network types and/or protocols and/or mark up languages and/or applications may be used.

In certain embodiments of the present invention, one or more loan application processing tools or services may be provided for use by lenders. Computing devices 120 may provide such processing tools or services for computing devices 110. In certain embodiments of the present invention, business and/or logic rules implemented may be customized to particular lender's preferences. For example, a minimum credit score for approval may be lender specific. Further, whether or not to continue processing once a loan denial indicative outcome is determined, or whether to cease processing of the loan application, may be lender specific.

Certain embodiments of the present relate to providing consumer data useful for processing loan applications. Such a provision may be based, at least in part, on prior requests for similar information. For example, in certain embodiments of the present invention information provided in response to a request associated with a loan application may be based at least in part upon prior requests associated with prior loan application.

Third parties, such as vendors, service providers, lenders, other credit extending third parties, information requestors and/or partners for example, may submit credit related information in a similar manner as for conventional credit reporting. For example, information, such as historical transaction and/or account information may be provided in a form suitable for being imported into one or more databases using conventional methodologies.

Referring again to FIG. 1, class 110 computing devices may correspond to such partners and class 120 computing devices may correspond to a system and utilize methods according to embodiments of the present invention. One or more files including such credit related information may be submitted from devices 110 to devices 120 for batch processing and storing in one or more databases in a manner analogous to that done for conventional credit reporting agencies.

For example, such submissions may be made in comma separated value (CSV) type or Microsoft Excel type files. The individual reported elements may substantially correspond to one or more industry accepted format elements. For example, applicant name, social security number, address, phone number(s), date of birth, account numbers, account open/close dates, account types, payments, amounts owing and amounts past due may be indicated, all by way of non-limiting example. Reported accounts may relate to Internet, bricks and mortar, and instant or near instant loans, bill payments (such as water, sewer, trash, electric, gas, taxes, credit cards, automobile, insurance, television, phone, retail store and others), savings, checking, check cashing transactions, debt consolidation, child or family support obligations, credit lines, debit card accounts, real estate and rental agreements, loans and other types of financial and/or debt related instrumentalities. Accordingly, one or more databases utilized in certain embodiments of the present invention may reflect virtually any type of credit extended to a consumer or loan applicant.

In certain embodiments of the present invention, such a database may be populated, either in addition to or in lieu of the above, in real-time with loan application processing requests and further reports. Such further credit reports may be provided by computing devices 110 to computing devices 120 in a markup language type format, such as an Extensible Markup Language (XML) type format. Such functionality may be particularly well-suited for single transactions or other events and be reported by members in real-time, and the database updated in real time. Such submission may be substantially in accordance with one or more industry accepted formats, for example.

In certain embodiments of the present invention, requests for creditworthiness information may be received for processing using such database(s) and/or embodiments of the present invention. Such requests may be from partners corresponding to computing devices 110. In such a case, information akin to that of conventional bureau requests may be provided from computing devices 110 to computing devices 120, where it is parsed and used for processing in accordance with embodiments of the present invention. Computing devices 120 may then return creditworthiness information determined by the processing to the requesting computing devices 110.

Accordingly and substantially departing from conventional credit bureau services, certain embodiments of the present invention provide for a real-time credit bureau services. Certain embodiments of the present invention leverage that under-banked and near prime consumers' lives change very frequently. This velocity of change applies to their work, personal, and financial interactions. A single negative life event does not normally impact the creditworthiness of a traditionally high credit score consumer. However, it could change the under-banked or near prime consumers credit picture dramatically. The reporting cycles for conventional credit bureaus displaying 30-day old data do not accurately reflect the risks in the under-banked and near prime consumer markets. Certain embodiments of the present invention provide for data moving into and out of the system in real-time.

While certain embodiments of the present invention may be particularly well suited for under-banked and near prime consumers, the invention is not so limited. Nonetheless, these consumers tend to have the least amount of useful recorded data in a traditional bureau file. They don't live in the world of American Express Centurion Cards, million-dollar mortgages, and substantial stock portfolios. They may typically race their paychecks to the bank to prevent prior checks from bouncing. To accurately assess the creditworthiness of these consumers, embodiments of the present invention advantageously focus on the velocity with which consumers experience change in their lives. Making a decision on the creditworthiness of these consumers should not solely rely on a typical evaluation of historical credit behavior. If a consumer was late or defaulted on an obligation a year ago, they may have intentionally defrauded the creditor, chosen not to meet the obligation, or were not able to pay due to life events. Lenders may need to know more.

Consistently, certain embodiments of the present invention may be directed to a system for providing creditworthiness information based on a credit application, including at least one database storing a plurality of information elements corresponding to credit information; and at least one server. The server may be configured to: receive at least one data file including first additional information elements and store the additional data elements in the at least one database using batch processing; receive at least one record including second additional information elements and storing the second additional information elements in the database substantially contemporaneously with their being received; receive creditworthiness requests; query the at least one database including the information elements, first additional information elements and second additional information elements dependently upon the received requests substantially contemporaneously with the requests being received to generate query results; and transmit creditworthiness indicative information based upon the query results substantially contemporaneously with the query results being generated.

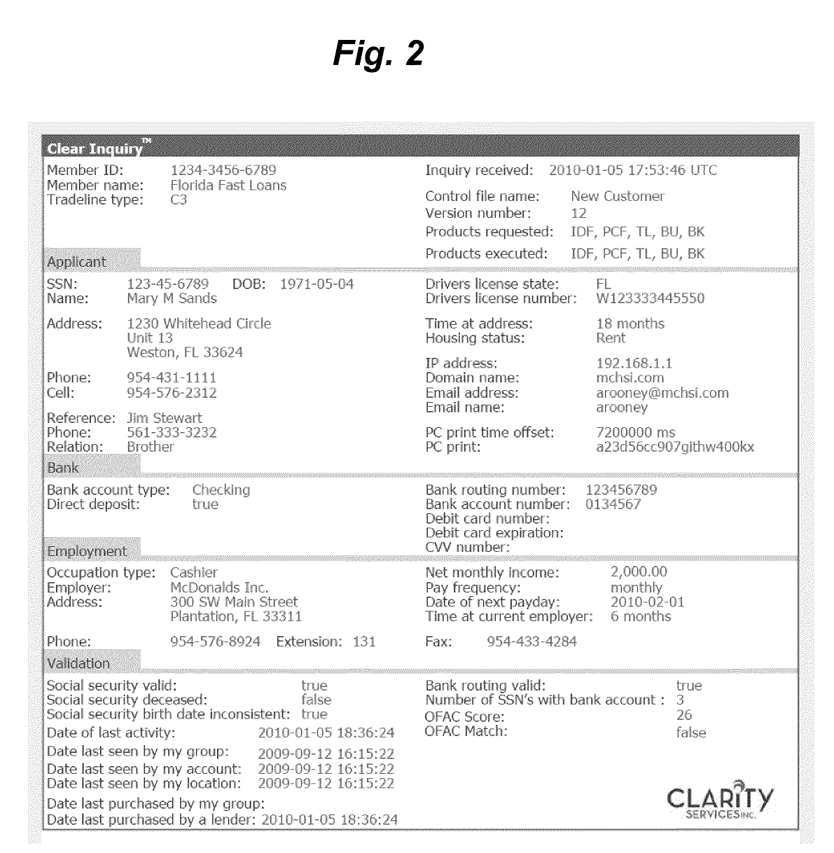

In certain embodiments of the present invention, pre-processing validation may be utilized. Referring now to FIG. 2, there is shown an example of a report suitable for presenting consumer data as submitted for processing in connection with loan applications. Such information may have been submitted by computing devices 110 to computing devices 120, where it was parsed and stored in one or more databases. A query of the database(s) based upon the submission (e.g., the submitted inquiry) may return corresponding stored information elements, including the illustrated inquirer indicative information, applicant information, bank account information and employment information of FIG. 2. Some or all of the elements may be submitted to pre-processing and validation. Non-limiting examples of results of such processing and validation are illustrated as the validation information. For example, the validity of a submitted social security number and bank account may be determined. Whether the social security number is known to belong to a deceased may be determined. The number of social security numbers that have been previously submitted in loan applications for the submitted bank account may be determined. Whether the social security number is inconsistent with a submitted birth date may be determined. One or more prior submissions having corresponding information elements may be determined. Whether elements of the applicant's information are associated with one or more lists of persons, such as an Office of Foreign Assets Control list may be determined.

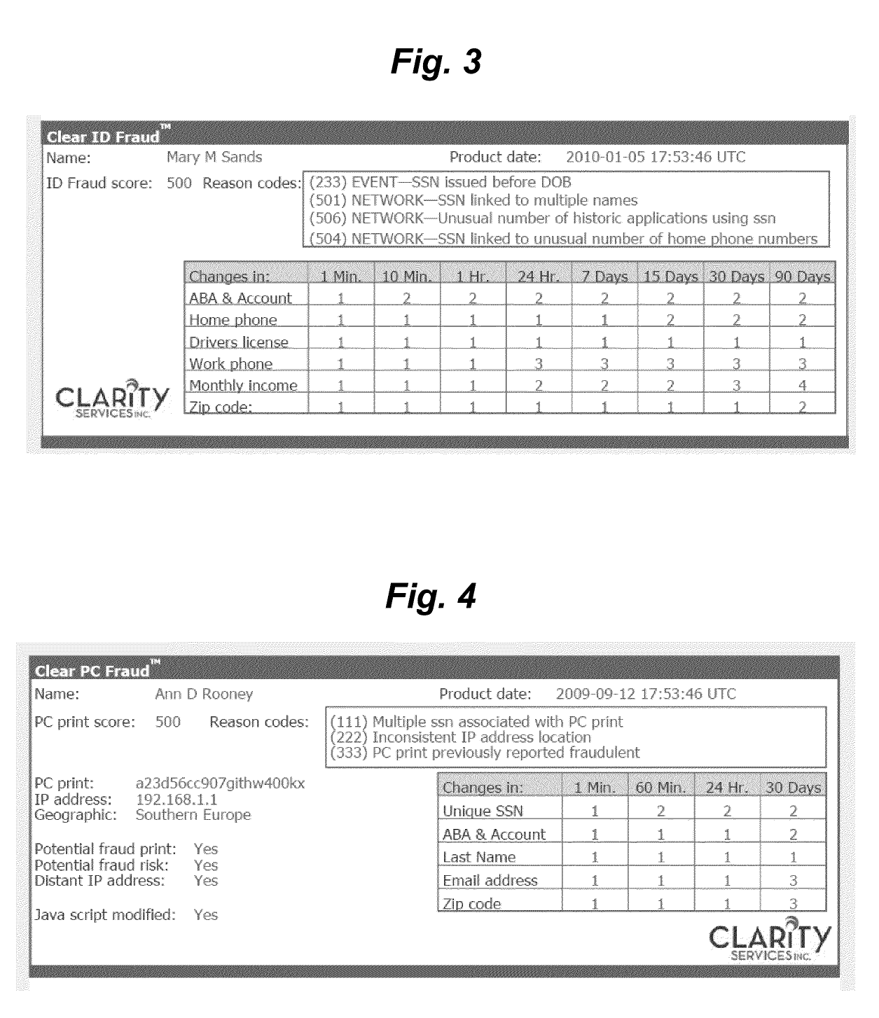

Certain embodiments of the present relate to identifying loan applicants that may be attempting to commit identity fraud. Referring now to FIG. 3, there is shown an example of a report suitable for identifying loan applicants that may be attempting to commit identity fraud.

The report of FIG. 3 may be particularly well-suited for use as an identity fraud management solution. Such a report may be based upon non-traditional identity data and verification techniques to overcome weaknesses and false positives inherent with conventional identity verification products. For example, loan applicants may be checked against non-traditional data—such as cell phone billing records, check cashing records and credit application records.

Further, instead of merely looking for specific name and address matches in a loan applicant's data, certain embodiments of the present invention may identify fraudulent patterns associated with a loan applicant. With this type of approach, it is possible to separate intentional fraud from a simple mis-keyed social security number.

Referring still to FIG. 3, according to certain embodiments of the present invention a score based on a determined overall fraud risk associated with an applicant's identity may be provided as an “ID Fraud score”. Certain embodiments of the present invention may utilize scoring provided using ID Analytics, Inc. of San Diego, Calif. Such an approach may help distinguish relatively innocent mistakes in typing or otherwise entering credit application related information versus intentional fraud in credit applications.

According to certain embodiments of the present invention, one or more of the most pertinent reasons why an applicant's fraud score is less than perfect may be provided as “Reason codes”. Some non-limiting examples of reason code related reasons may include: reasons related to social security invalidity or questionability (e.g., invalidity, issued before birth date, associated with multiple names or addresses, high number of historic applications associated with the social security number), name and address. In certain embodiments of the present invention, these codes may be provided with a score in a conventional manner, such as by a third party like ID Analytics.

According to certain embodiments of the present invention, a time-scaled report of changes in demographic elements that have been supplied by the same applicant in a given period of time may be provided. In the example report of FIG. 3, it takes the form of a matrix (sometimes termed as a stability grid) that demonstrates how many changes between loan applications for a common applicant have occurred over certain periods of time. In the illustrated case of FIG. 3, changes in ABA and bank account information, home and work phone numbers, drivers license number, monthly income and postal zip code are determined for 1 minute, 10 minute, 1 hour, 24 hour, 7 days, 15 days, 30 days and 90 days time intervals.

In certain embodiments of the present invention, such a report may be generated by querying the one or more databases for historical loan applications for a subject loan applicant, and comparing the information previously submitted against both itself and the information in the present application.

In certain embodiments of the present invention, instability demonstrated by the matrix may be used to indicate a likelihood that identity fraud may be present, and thus provide an indication of creditworthiness. For example, the greater the indicated instability, the greater a likelihood that fraud may be present and the greater a lack of creditworthiness may exist.

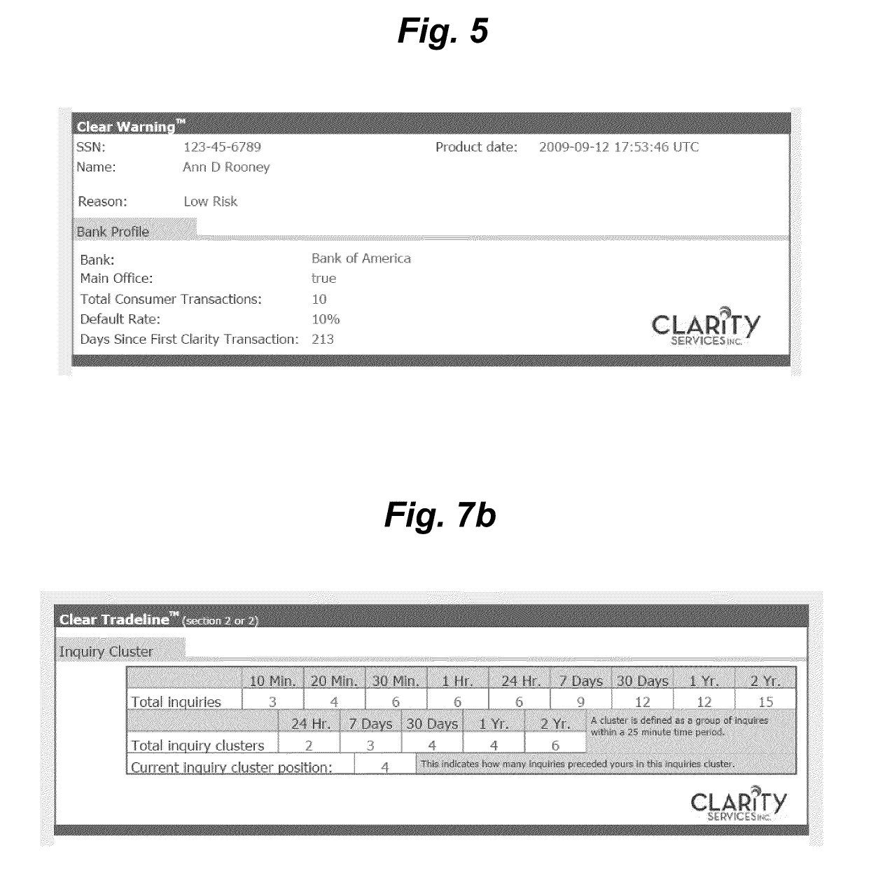

Certain embodiments of the invention relate to identifying loan applicants that are related to a common computing device. Referring now to FIG. 4, there are shown an example report suitable for identifying loan applicants that are related to a common computing device. Such a report may be useful for identifying potentially fraudulent loan applications corresponding to a single applicant, for example.

Such a report may combine computing device identification technology with one or more loan applicant databases to identify high-risk characteristics and activities related to the specific computing devices used by online applicants. Such an approach allows a user to view how many different demographic elements or distinct identities are being generated by or otherwise correspond to a particular applicant's computing device in a given time period. Certain embodiments of the present invention may not require user involvement, hardware deployment, or disruption to a loan applicant's application experience. Certain embodiments of the present invention may not rely solely on IP addresses or install any software, and be relatively undetectable by a loan applicant's computing device.

In certain embodiments of the present invention, such functionality may be provided using commercially available products or services, such as those provided by 41^{st} Parameter. By way of further, non-limiting example, one or more pieces of code may be embedded in websites used by applicants to provide loan application information, such as websites provided by or that feed computing devices 110. This code may provide computing device identifiers to computing devices 120, such as a PC fingerprint. The so-called fingerprint may be stored in the one or more databases so as to be associated with loan applications that are also received.

Referring still to FIG. 4, a score (e.g., PC print score) and a set of reason codes based on the overall fraud risk associated with an applicant's computing device may be provided. In certain embodiments of the present invention, loan application submissions provided by computing devices 110 to devices 120 may include an at least substantially unique identifier associated with the corresponding applicants' computing device used to provide the loan application information. The score may be determined using conventional scoring methodologies based upon occurrences and/or frequency of demographic elements in loan applications associated with the so-called fingerprint. For example, the number of applications containing different information elements (e.g., different social security numbers) emanating from a common computing device may be used as a basis for the score, along with the frequency thereof.

In certain embodiments of the present invention, a time-scaled report of demographic elements and identities that have been supplied using a common computing device in a given period of time may be provided. In the example report of FIG. 3, it takes the form of a matrix (sometimes termed a “stability grid”) that demonstrates how many changes between loan applications emanating from a common computing device have occurred in certain periods of time. In the illustrated case of FIG. 4, changes in social security number, ABA and bank account, last name, e-mail address and zip code are determined for 1 minute, 60 minute, 24 hour and 30 day time intervals.

Certain embodiments of the present invention provide additional information about a loan applicant's computing device to enhance fraud risk decision making. For example, in the illustrated embodiment of FIG. 4, a unique string of characters used to uniquely identify the loan applicant's computing device is provided as a “PC print”. The indicated IP address used by the loan applicant is provided as an “IP address”. The geographic region in which the loan applicant's computing device actually resides is provided as a “geographic” indication. In certain embodiments of the present invention, an IP address associated with the application's submission or completion may be included as part of a creditworthiness inquiry, and the geography of that IP address determined.

Referring still to FIG. 4, a “potential fraud print” “yes” indicates the loan applicant's specific PC Print is present in a database of reported fraudulent computing devices. This may be determined by comparing the PC Print to a known database of prior PC Print related applications and/or transactions, for example. A “potential fraud risk” “yes” indicates an analysis of the loan applicant's computing device shows fraudulent characteristics. A distant IP address” “yes” indicates a loan applicant's computing device has used an IP address geographically different from the given address.

Referring yet to FIG. 4, a “JAVA script modified” “yes” indicates modifications to the loan applicant's computing device operating system that could potentially mask fraudulent intent have been detected. In certain embodiments of the present invention, such functionality may be provided using commercially available products or services, such as those provided by 41^{st} Parameter. Such an application may return an indication of one or more JAVA or other similar settings on the computing device used to complete or originally submit the application (e.g., to devices 110) to devices 120.

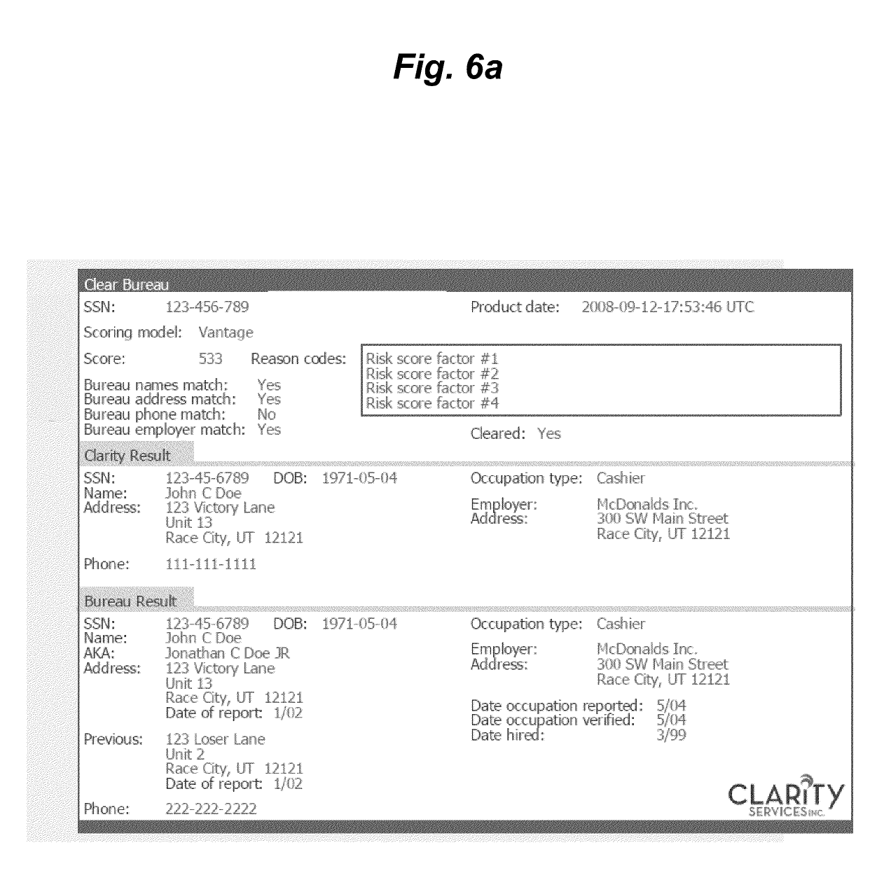

Certain embodiments of the present relate to providing bank account risk ranking. Referring now to FIG. 5, there is shown an example of a report suitable for providing bank account risk information.

In the illustrated embodiment of FIG. 5, there is shown information relating to a bank account identified in a loan application. It identifies the applicant by name and social security number. These may be parsed or queried from the application data received in an inquiry, along with the other information elements thereof, for example. This information may be used to determine additional information that may be indicative of the applicant's creditworthiness, such as by using commercially available products like those available from Early Warning Services, LLC.

The embodiment of FIG. 5 further shows the bank name, and whether the account is associated with the main office of that bank, or a satellite branch. In certain embodiments of the present invention, bank routing information for provided bank accounts may be used to determine the corresponding bank routing code in a conventional manner. In certain embodiments of the present invention, main office or satellite branch, and/or other information can be drawn from the bank routing number and compared against information items stored in the at leas one database indicative of known bank routing numbers and known characteristics of their corresponding banks.

The embodiment of FIG. 5 further shows the total number of recorded transactions reported to or processed by embodiments of the present invention associated with the indicated main or branch office. This may be determined by comparing the bank routing number with those of recorded transactions, for example. The embodiment of FIG. 5 further identifies a default rate associated with transactions with the indicated main or branch office. This may be determined by identifying what percentage of the indicated transactions have database entries indicating a reported default condition. The embodiment of FIG. 5 further shows the number of days that have elapsed since the first loan application or other transaction associated with the indicated bank routing number.

In certain embodiments of the present invention, such a report may be generated by querying the one or more databases, and comparing the information previously submitted against the information in the present application.

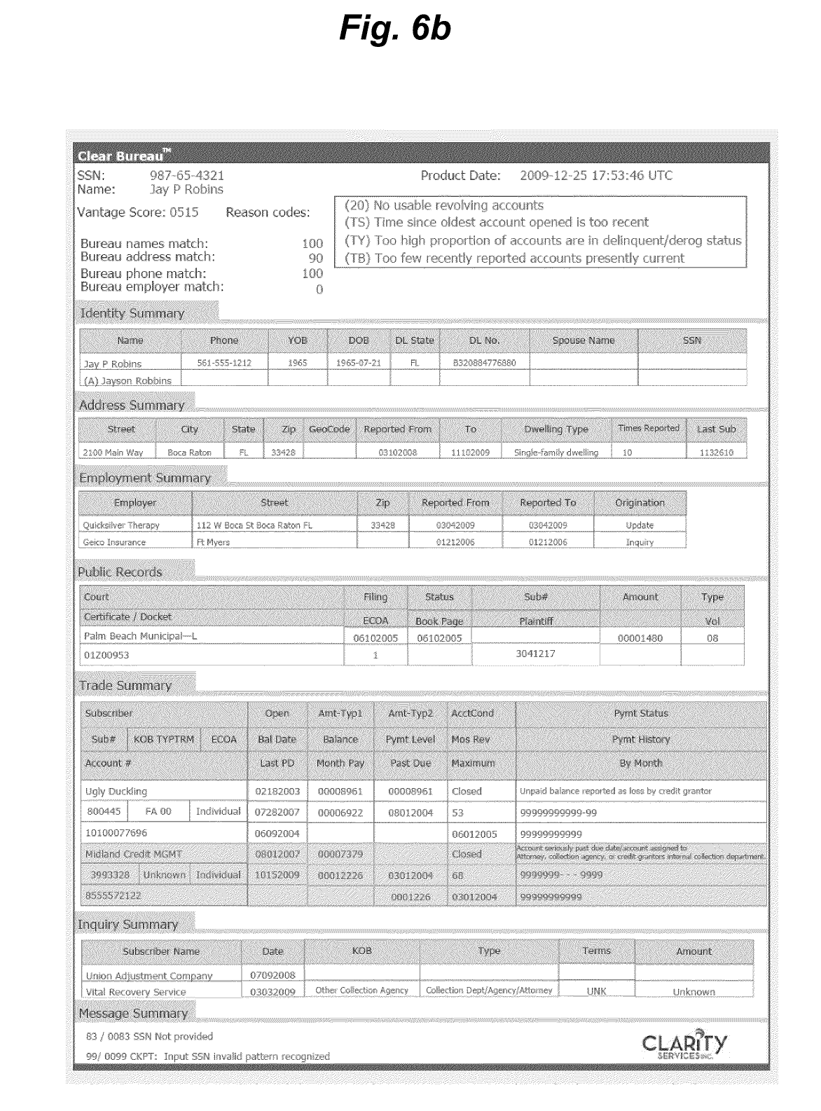

Certain embodiments of the present relate to loan application approval/denial processing and/or automation of underwriting functions. Referring now to FIGS. 6a and 6b, there are shown examples of such reports.

In certain embodiments of the present invention, a third party credit bureau report, such as an Experian credit report and any of their scoring models and reason code sets that a user selects, may be presented. In certain embodiments of the present invention, such the third party's header data may be compared with current information stored in the one or more databases, and a list of comparison flags presented. Such an approach may provide for improved automation of underwriting decisions, as discussed in more detail below. In certain embodiments of the present invention, a user can automate decisions based upon elements in the traditional third party credit report, yet still in a scalable manner using a credit reporting bureau-type service.

Referring still to FIG. 6a, in certain embodiments of the present invention, such a report may provide the risk scoring model and reason code set that a user has chosen for the third party credit report; a list of comparison flags detailing discrepancies between the third party's and the system's header data; both the third party's and system's most recent header details; and the complete third party credit report.

In the illustrated case of FIG. 6a, the report includes the social security number (SSN) given on the inquiry; the date and time of the inquiry; the credit scoring model selected from the third party credit bureau (Vantage score); the credit score provided by the third party credit bureau on this report (0515) and the reason codes provided by the third party credit bureau related to their credit score (Reason codes).

The illustrated embodiment of FIG. 6a further shows the system and the third party credit bureau header data comparison flags (bureau names, address, phone and employers match). This can be determined by comparing historical data available to the system in the one or more databases to the third party report. Additionally, the embodiment of FIG. 6a also shows the most recent system and bureau demographic information (Clarity or system result, bureau result).

The embodiment of FIG. 6b illustrates a different detail level of such a report.

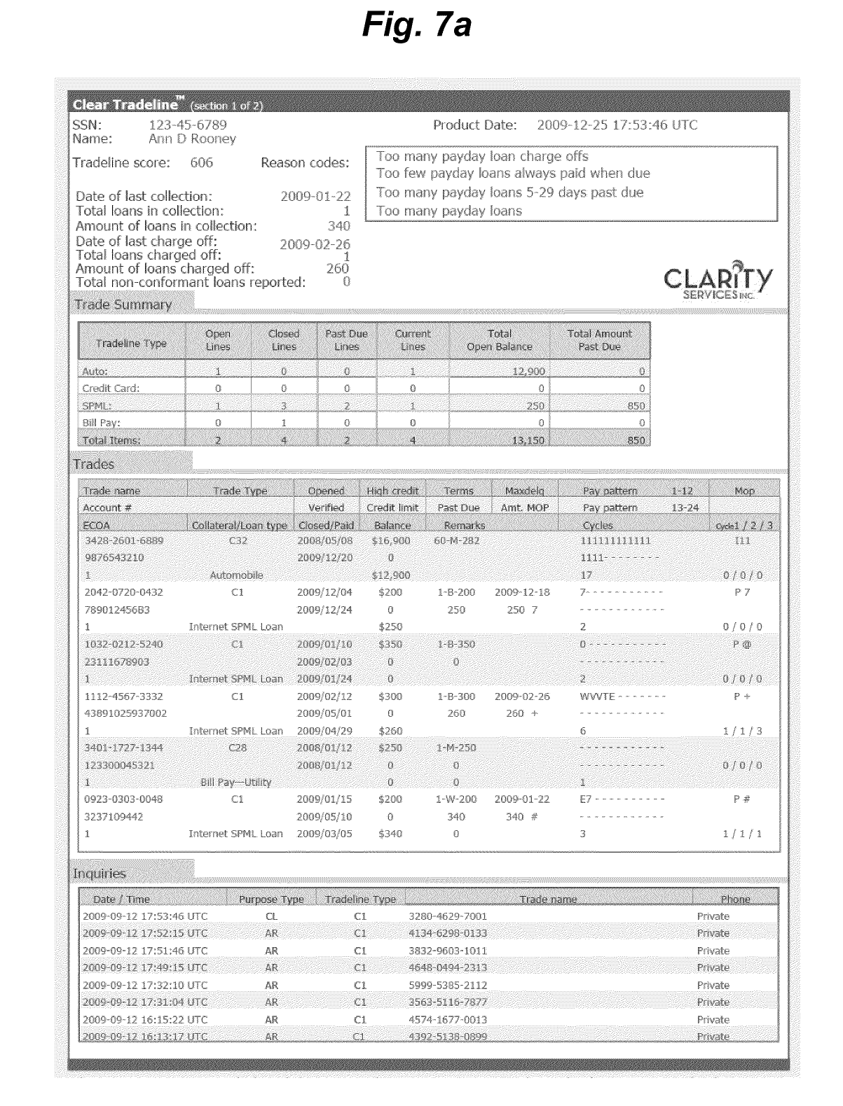

Certain embodiments of the invention relate to providing real-time credit reporting. Referring now to FIGS. 7a and 7b, there are shown examples of reports suitable for providing real-time credit reporting.

Certain embodiments of the present invention provide credit inquiries, extensions of credit, bill payments, and collection attempts made by reporting entities, such as partners. These entities may offer a variety of financial products such as home mortgages, credit cards, debit cards, auto loans, single payment micro loans, rent-to-own, and bill payment services. As discussed above, reporting data may be accepted and displayed in an industry accepted format. Of course, other formats may be used.

According to certain embodiments of the present invention, and as also discussed above the format may accept real-time reporting changes on an extensive and more contemporary set of products than the traditional credit bureaus.

The illustrative reports of FIGS. 7a and 7b include elements to help users evaluate the credit risk associated with loan applicants. For example, such a report may provide a risk score and reason codes based on the loan applicant's inquiry and trade line history. Such a report may provide both a summary and detailed view of a loan applicant's trade line history. Such a report may provide a detailed real-time history of the loan applicant's past inquiry traffic, such as beginning from the most recent inquiry. Such a report may provide a summary of inquiry transactions within predefined time parameters.

Referring still to FIGS. 7a and 7b, the illustrative report provides the full name and social security number given on this specific inquiry, as well as the date and time of the subject inquiry. The report includes a weighted lending risk score and set of reason codes for the score being less than perfect (e.g., tradeline score and reason codes). Such a scoring may be based upon conventional scoring techniques that evaluate details of consumers credit, as well as a recency and frequency of events, such as changes in application information. The report includes a trade line summary providing an overview of the loan applicant's detailed trade line information, and a detail view of the loan applicant's reported trade line activity.

The report of FIGS. 7a and 7B includes a detailed list of the most recent transactions. The report also includes an inquiry cluster (or frequency/time evaluation) section. In certain embodiments of the present invention, a single loan application may spawn multiple creditworthiness inquiries. For example, lenders may purchase consumer applications from a third party in addition or lieu of capturing credit applications themselves. Hence multiple lenders may purchase a common application, leading to multiple inquiries. Multiple inquiries may convention affect creditworthiness determinations. Certain embodiments of the present invention address this potential misprocessing by grouping inquiries received into temporal periods that may indicate they emanate from a common application, rather than separate applications.

In certain embodiments of the present invention, such a report may be generated by querying the one or more databases for information items corresponding to the subject loan applicant.

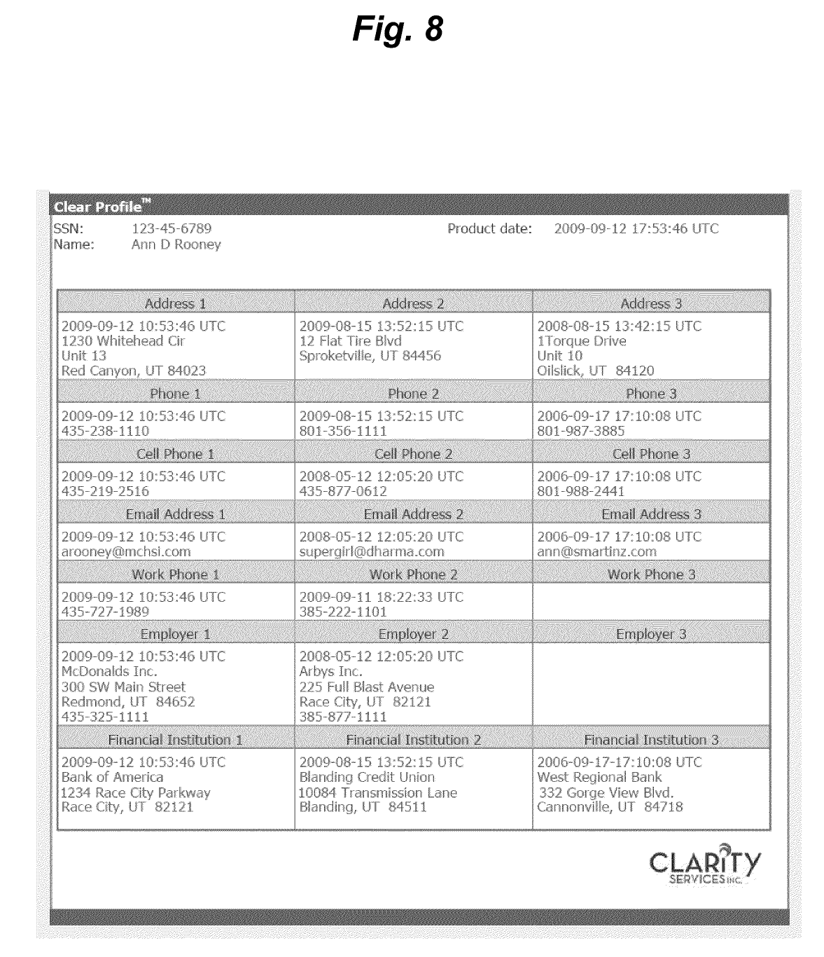

Certain embodiments of the present relate to providing recent-historical loan applicant demographic information. Referring now to FIG. 8, there is shown an example of a report suitable for providing recent-historical loan applicant demographic information. Such a report may be useful for loan collections processing, for example.

Such a report may be based upon a report of ones of the real-time updated databases and provide a predetermined collection, such as the last three, demographic elements associated with a creditor's previous applications.

Referring still to FIG. 8, the illustrated report includes the name and social security number given on this specific inquiry, as well as the date and time of this report request. The report provides the last three addresses submitted by this applicant in previous inquiries submitted to the system for processing, or otherwise provided to the system, such as via a partner submission. The report includes the last three home phone numbers submitted in an analogous manner. The report includes the last three cell phone numbers submitted in an analogous manner. The report includes the last three email addresses submitted in an analogous manner. The report includes the last three work phone numbers submitted in an analogous manner. The report includes the last three employers submitted in an analogous manner. The report includes the last three banks or prepaid debit card accounts submitted in an analogous manner. Such reports may be generated using conventional-type queries of previous loan application information stored in one or more databases and/or provided by partners, for example.

In certain embodiments of the present invention, such a report may be generated by querying the one or more databases for information items corresponding to the inquiry.

According to certain embodiments of the present invention, the illustrated reports, and/or data indicative of the date therein, may be transmitted by computing devices 120 to the corresponding requesting ones of the computing devices 110. In certain embodiments of the present invention, they may be considered as part of a conventional loan application decision process by partner personnel. In certain embodiments of the present invention, at least a portion of the transmitted information may be processed automatically using computing devices 110 (or other computing devices communicative coupled thereto) to automate the loan application decision process.

According to certain embodiments of the present invention, loan application decisions may be substantially automated based upon reported information. For example, configurations corresponding to particular partners, e.g., creditworthiness inquirers or requesters, and types of reports desired, e.g., an ID and PC fraud related inquiry, may be defined, such as by using configuration types and corresponding files. Such files may also be associated with various levels of granularity, e.g., such as by partner and/or partner sub-types, for example.

Such a control file may serve as a backbone to the inquiry infrastructure. It may manage configuration settings, inquiry requests, report responses and decision statements to create output tailored to specific requirements. Such files may be created at either partner, partner location or sub-levels, for example.

In certain embodiments of the present invention, a default control file may be used. Such a file may provide for: report or product selection and sequencing; 2) response detail levels; 3) decision language and 4) whether processing should continue once an application denial criteria is met.

By way of further, non-limiting example, a product selection and sequence setting may enable a partner to choose which reports are desired. For example, a configuration file may designate which fraud detection reports should be run. The order in which they are to be run may also be defined.

By way of further, non-limiting example, a response detail level setting may enable a partner, or requester, to choose how much detail they want returned with the response. This may indicate what verbosity level is desired in reports. For example, it may designate which of 4 detail levels are to be includes: 1) Approve/Deny Only; 2) Approve/Deny+Scores; 3) Aggregate Data+Approve/Deny+Scores; or 4) Raw Data+Aggregate Data+Approve/Deny+Scores.

By way of further, non-limiting example, a decision language setting may enable a requester to add decision-based criteria to the control file. Such criteria, or decision statements, may be defined such that when true, a ‘DENY’ response results. In certain embodiments of the present invention decision statements may be linked together into more complex statements with the use of logical operators. The statements may be are evaluated in a FIFO manor (first in, first out) for example, which will be from top to bottom as they appear in the configuration file. For instance, a deny for a ID Fraud score of less than 500, may be automated at the credit bureau service level using a criteria akin to “Id_fraud_score<500”. If there was a request that includes or determines an ID Fraud score of 480, the decision language statement would be TRUE, and one of two actions will be taken based on the value of the Continue on Deny setting.

By way of further, non-limiting example, a continue on deny setting may enable a requester to choose to continue processing subsequent reports, even though a report had a deny response. For example, if a requesting partner needs additional information beyond the criteria that resulted in a deny response, that information can nonetheless be returned by selecting an appropriate setting. Further, it such information is not needed, a deny response may instead be returned and processing halted. Advantageously, this may lessen system requirements by eliminating unnecessary processing, thus resulting in a lower overall cost of operation. For example, a requester may not be charged for reports not actually run.

By way of further, non-limiting example, a particular type of request corresponding to a particular type of inquiry for a particular inquirer (e.g., partner) may be a “new customer” type of search for a particular office of a particular partner. Such a request may be take the form of a markup language type request. For example, it may take the form of request from one of computing devices 110 to computing devices 120 (FIG. 1) and be in a format that includes items akin to:

```
    <partner_identifier>VALUE</partner_identifier>
<partner_sub_identifier>VALUE</partner_sub_identifier>
    <location_identifier>VALUE</location_identifier>
        <username>VALUE</username>
          <password>VALUE</password>
    <Control_file_name>VALUE</Control_file_name>
  <Control_file_version>VALUE</Control_file_version>
      <inquiry_purpose>VALUE</inquiry_purpose>
```

Such a format may invoke the identified control file, such a “new customer control file. That file may indicate that certain reports are to be generated, such that appropriate queries are executed and results determined and gathered. Such a control file may include parameters that create decision filters that drive decision flags, such as particular address fields, income fields and ID fraud scores meeting certain criteria. Decision indicative data may be communicated with and/or in lieu of some or all of the determined and/or gathered query results.

Thus, according to certain embodiments of the present invention, a system for providing creditworthiness information based on a credit application from a plurality of requestors may be provided. Such a system may include at least one database storing a plurality of information elements corresponding to credit information and a plurality of configuration types each corresponding to one of the requestors and a type of request; and at least one server. The at least one server may be configured to: receive creditworthiness requests from the requestors; determine which of the configuration types corresponds to each of the received requests; query the at least one database dependently upon the received requests substantially contemporaneously with the requests being received and in accordance with the determined configuration files to generate query results; and transmit creditworthiness indicative information based upon the query results substantially contemporaneously with the query results being generated; wherein the types of transmitted information may differ based upon the determined configuration types.

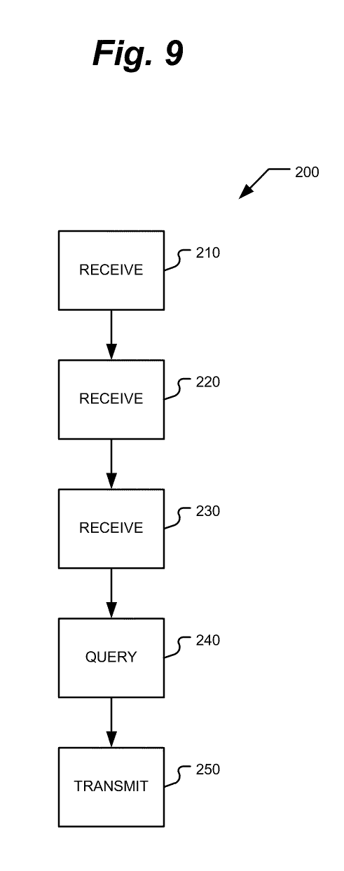

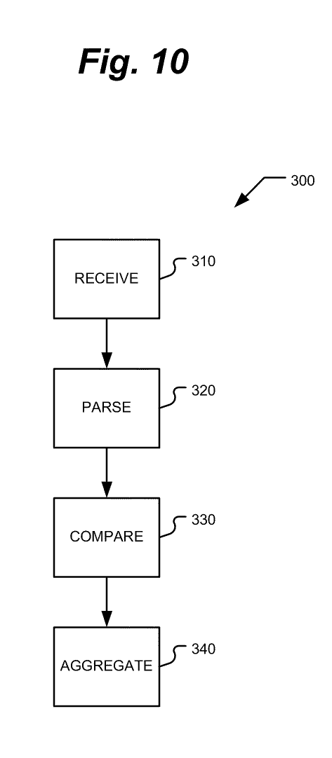

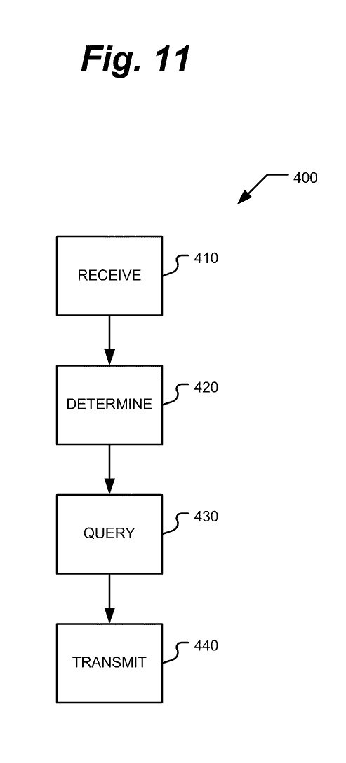

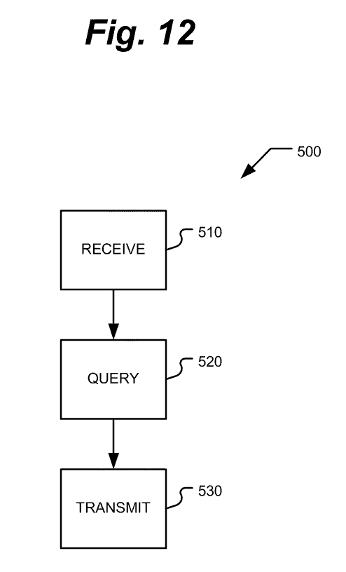

Referring now to FIGS. 9-12, there are shown flow diagrams of processes 200, 300, 400 and 500 according to certain embodiments of the present invention.

Process 200 may be suitable for use with a system for providing creditworthiness information based on a credit application. Such a system may include a plurality of information elements corresponding to credit information in at least one data store. Process 200 includes receiving 210 at least one data file including first additional information elements and store the additional data elements in the at least one database using batch processing. Process 200 includes receiving 220 at least one record including second additional information elements and storing the second additional information elements in the database substantially contemporaneously with their being received. Process 200 includes receiving creditworthiness requests at block 230. Process 200 includes automatically querying the at least one database including the information elements, first additional information elements and second additional information elements dependently upon the received requests substantially contemporaneously with the requests being received to generate query results at block 240. And, process 200 includes automatically transmitting creditworthiness indicative information based upon the query results substantially contemporaneously with the query results being generated at block 250.

Process 300 may be suitable for use with a system for providing creditworthiness information in response to an application having a corresponding applicant. Process 300 includes receiving a data representation of at least a portion of the application at block 310. Process 300 includes parsing out information items in the received data at block 320. Process 300 includes comparing at least one of the parsed out information items to information items corresponding to prior applications also corresponding to the applicant at block 330. Process 300 includes for each of a plurality of temporal periods, reporting an aggregate of: (1) a number of information item inconsistencies determined to exist between the at least one parsed information item and the previously parsed information items received in the corresponding temporal period; and (2) inconsistencies in the previously parsed information items received in the corresponding temporal period, at block 340.

Process 400 may be suitable for use with a system for providing creditworthiness information based on a credit application from a plurality of requestors. Process 400 may be suitable for use with at least one database storing a plurality of information elements corresponding to credit information and a plurality of configuration types each corresponding to one of the requestors and a type of request. Process 400 includes receiving creditworthiness requests from the requestors at block 410. Process 400 includes determining which of the configuration types corresponds to each of the received requests at block 420. Process 400 includes querying the at least one database dependently upon the received requests substantially contemporaneously with the requests being received and in accordance with the determined configuration files to generate query results at block 430. Process 400 includes transmitting creditworthiness indicative information based upon the query results substantially contemporaneously with the query results being generated at block 440. The types of transmitted information may differ based upon the determined configuration types.

Process 500 may be suitable for use with a system for providing creditworthiness information based on a credit application. Process 500 may be suitable for use with at least one database storing a plurality of information elements corresponding to credit information and particular computing device indicative information. Process 500 includes receiving a creditworthiness request at block 510. Process 500 includes querying the at least one database including the information elements and the particular computing device indicative information dependently upon the received request substantially contemporaneously with the request being received to generate query results at block 520. Process 500 includes transmitting creditworthiness indicative information based upon the query results substantially contemporaneously with the query results being generated at block 530.

It will be apparent to those skilled in the art that modifications and variations may be made in the systems and methods of the present invention without departing from the spirit or scope of the invention. It is intended that the present invention cover the modifications and variations of this invention provided they come within the scope of the appended claims and their equivalents.

What is claimed is:

1. A system for providing creditworthiness information based on a credit application, comprising:
at least one database storing a plurality of information elements corresponding to credit information; and
at least one server configured to:
receive at least one data file including first additional information elements and store the additional data elements in the at least one database using batch processing;
receive at least one record including second additional information elements and storing the second additional information elements in the database substantially contemporaneously with their being received;
receive creditworthiness requests;
automatically query the at least one database including the information elements, first additional information elements and second additional information elements dependently upon the received requests substantially contemporaneously with the requests being received to generate query results; and
automatically transmit creditworthiness indicative information based upon the query results substantially contemporaneously with the query results being generated.

2. The system of claim 1, wherein the transmitted creditworthiness indicative information includes at least one of information item selected from the group consisting of a fraud indicative information item, an information instability indicative information item, a computing device indicative information item; a third party credit bureau information item, a bank or bank account indicative information item and a demographic information item.

3. The system of claim 1, wherein the at least one file includes a plurality of records and the received at least one record is in a markup language format.

4. The system of claim 1, wherein
the at least one database further stores a plurality of configuration types each corresponding to one of a plurality of requestors and a type of request;
the at least one server is also configured to determine which of the configuration types corresponds to each of the received requests;
the querying the at least one database is in accordance with the determined configuration files to generate query results; and
the types of transmitted information may differ based upon the determined configuration types.

5. A system for providing creditworthiness information in response to an application having a corresponding applicant, comprising at least one server configured to:
receive a data representation of at least a portion of the application;
parse out information items in the received data;
compare at least one of the parsed out information items to information items corresponding to prior applications also corresponding to the applicant; and
for each of a plurality of temporal periods, reporting an aggregate of: (1) a number of information item inconsistencies determined to exist between the at least one parsed information item and the previously parsed information items received in the corresponding temporal period; and (2) inconsistencies in the previously parsed information items received in the corresponding temporal period.

6. The system of claim 5, wherein the reported aggregate is accompanied by at least one of information item selected from the group consisting of a fraud indicative information item, a computing device indicative information item; a third party credit bureau information item, a bank or bank account indicative information item and a demographic information item.

7. The system of claim 5, wherein the reporting comprises forming a matrix illustrating the temporal periods and aggregates.

8. The system of claim 5, further comprising generating a score indicative of a likelihood of fraud in the application based upon the aggregates and a plurality of rules.

9. The system of claim 8, further comprising reporting ones of the rules having a substantial impact on the generated score.

10. A system for providing creditworthiness information based on a credit application from a plurality of requestors, comprising:
at least one database storing a plurality of information elements corresponding to credit information and a plurality of configuration types each corresponding to one of the requestors and a type of request; and
at least one server configured to:
receive creditworthiness requests from the requestors;
determine which of the configuration types corresponds to each of the received requests;
query the at least one database dependently upon the received requests substantially contemporaneously with the requests being received and in accordance with the determined configuration files to generate query results; and
transmit creditworthiness indicative information based upon the query results substantially contemporaneously with the query results being generated;
wherein the types of transmitted information may differ based upon the determined configuration types.

11. The system of claim 10, wherein the transmitted creditworthiness indicative information includes at least one of information item selected from the group consisting of a fraud indicative information item, an information instability indicative information item, a computing device indicative information item; a third party credit bureau information item, a bank or bank account indicative information item and a demographic information item.

12. The system of claim 10, wherein each configuration type comprises a configuration file that identifies the querying.

13. The system of claim 10, further comprising applying a criteria to at least a portion of the query results prior to completing the querying, and selectively terminating the querying based on the applying.

14. The system of claim 13, further comprising applying a criteria to at least a portion of the query results prior to completing the querying, and continuing the querying regardless of the applying.

15. A system for providing creditworthiness information based on a credit application, comprising:
at least one database storing a plurality of information elements corresponding to credit information and particular computing device indicative information; and
at least one server configured to:
receive a creditworthiness request;
query the at least one database including the information elements and the particular computing device indicative information dependently upon the received request substantially contemporaneously with the request being received to generate query results; and
transmit creditworthiness indicative information based upon the query results substantially contemporaneously with the query results being generated.

16. The system of claim 15, wherein the transmitted creditworthiness indicative information includes at least one of information item selected from the group consisting of a fraud indicative information item, an information instability indicative information item, a third party credit bureau information item, a bank or bank account indicative information item and a demographic information item.

17. The system of claim 15, wherein the querying identifies a number of prior requests associated with the particular computing device indicative information associated with the received request.

18. The system of claim 17, wherein the querying identifies a number of different social security numbers or names or addresses associated with the particular computing device indicative information associated with the received request.

19. The system of claim 17, further comprising comparing a computing address associated with the received request to a physical address associated with the received request.

20. The system of claim 17, wherein the transmitting includes transmitting information indicative of the particular computing device indicative information associated with the received request.
